(19) United States
(12) Patent Application Publication
(10) Pub. No.: US 2015/0360208 A1
(43) Pub. Date: Dec. 17, 2015

(54) Formation Of Emission Control Catalysts

(71) Applicants: BASF SE, Ludwigshafen (DE); BASF Corporation, Florham Park, NJ (US)

(72) Inventors: René König, Ludwigshafen (DE); Knut Wassermann, Princeton, NJ (US); Kerstin Frank, Mannheim (DE); Caroline Mages-Sauter, Weinheim (DE)

(21) Appl. No.: 14/737,749

(22) Filed: Jun. 12, 2015

Related U.S. Application Data
(60) Provisional application No. 62/011,191, filed on Jun. 12, 2014.

(51) Int. Cl. B01J 23/63; B01D 53/94; B01J 37/08; B01J 37/00; B01J 35/00; B01J 35/02

(52) U.S. Cl. CPC B01J 23/63; B01J 35/0013; B01J 35/023; B01J 37/082; B01J 37/0072; B01D 53/945; B01D 2255/1023; B01D 2255/2065; B01D 2255/2063; B01D 2255/20715; B01D 2255/2092; B01D 2255/1025

(57) ABSTRACT

Provided are processes for the production of particles of catalytic material for emissions control obtainable in one-step from flame spray pyrolysis of precursor-containing dispersion(s), the method comprising: (1) providing a dispersion comprising one or more disperse phases and a continuous phase, the dispersion comprising: (a) a precursor compound of a first platinum group metal and a precursor compound of a first support, and (b) a precursor compound of a second platinum group metal and a precursor compound of a second support, wherein (a) is in a first phase that is different from a second phase containing (b); (2) forming an aerosol of the dispersion provided in step (1); and (3) pyrolyzing the aerosol of step (2) to obtain the particles of catalytic material. The catalytic particles comprise more than one support material and more than one platinum group metal, for use as, for example, three-way conversion (TWC) catalysts.

### CROSS-REFERENCE TO RELATED APPLICATIONS

This application claims priority under 35 U.S.C. §119(e) to U.S. Patent Application Ser. No. 62/011,191, filed Jun. 12, 2014, which is hereby incorporated by reference in its entirety.

### TECHNICAL FIELD

The present invention relates to a process for the production of emission control catalysts obtainable in one-step from flame spray pyrolysis of precursor-containing dispersions. Specifically, emission control catalysts containing more than one support material and more than one platinum group metal (PGM), such as three-way conversion (TWC) catalysts, may be obtained in one high temperature process step using the inventive process.

### BACKGROUND

Three-way conversion (TWC) catalysts are used in engine exhaust streams to catalyze the oxidation of the unburned hydrocarbons (HCs) and carbon monoxide (CO) and the reduction of nitrogen oxides (NOx) to nitrogen. The presence of an oxygen storage component (OSC) in a TWC catalyst allows oxygen to be stored during (fuel) lean conditions to promote reduction of NOx adsorbed on the catalyst, and to be released during (fuel) rich conditions to promote oxidation of HCs and CO adsorbed on the catalyst. TWC catalysts typically comprise one or more platinum group metals (PGM) (e.g., platinum, palladium, rhodium, and/or iridium) located upon one or more supports such as a high surface area, refractory oxide support, e.g., a high surface area alumina or a composite support such as a ceria-zirconia composite. The ceria-zirconia composite can also provide oxygen storage capacity. The support is carried on a suitable carrier or substrate such as a monolithic carrier comprising a refractory ceramic or metal honeycomb structure, or refractory particles such as spheres or short, extruded segments of a suitable refractory material.

PGM-containing catalytic converters are typically made from multiple components. With respect to three-way conversion (TWC) catalysts, for instance, dopant-stabilized ceria-zirconia, zirconia, and alumina are the most commonly used supports for PGM. In a conventional formulation process, PGM are dispersed onto different supports which are then slurried in the presence of additives. The slurry, upon reducing particle size by milling, forms a washcoat by coating a monolithic carrier. In such a process, the slurry formulation step has many variables which are often times not easy to control.

There is a continuing need in the art for catalytic materials that are made efficiently and whose ingredients are used efficiently.

### SUMMARY

A significant simplification of the overall process of making catalysts or catalytic material is achieved through the use of dispersions/emulsions that are subjected to flame spray pyrolysis. Design of a single dispersion/emulsion is to deliver a variety of precursors in specific ways to reduce unwanted interactions during preparation and synthesis and to enhance efficient use of materials. For example, the ingredients may be placed in different phases of the emulsion (for example, continuous phase versus droplets) and/or in non-coalescing complex emulsions (for example, in different droplets). In this way, the composition is freely adjustable. As a result, the various components of a desired catalytic material, for example, a three-way conversion (TWC) catalyst may be prepared in a single process step.

Provided are processes for the production of particles of catalytic material comprising: (1) providing a dispersion comprising one or more disperse phases and a continuous phase, the dispersion comprising: (a) a precursor compound of a first platinum group metal (PGM) and a precursor compound of a first support, and (b) a precursor compound of a second platinum group metal (PGM) and a precursor compound of a second support, wherein (a) is in a first phase that is different from a second phase containing (b); (2) forming an aerosol of the dispersion provided in step (1); and (3) pyrolyzing the aerosol of step (2) to obtain the particles of catalytic material.

A first disperse phase may comprise (a) and a second disperse phase may comprise (b). Alternatively, wherein one disperse phase may comprise (a) and the continuous phase may comprise (b).

The first support may comprise an alumina component and the second support may comprise a ceria component optionally with a zirconia component. The first PGM may comprise a palladium, rhodium, or platinum component, or mixtures thereof, and the second PGM may comprise a palladium, rhodium, or platinum component, or mixtures thereof that is different from the first PGM.

The dispersion may further comprise a precursor compound of an alkaline earth metal oxide in a phase different from the phases of (a) and (b). The alkaline earth metal oxide may comprise one or more of a barium, strontium, calcium, or magnesium component.

The one or more disperse phases may comprise a hydrophilic solvent system. The hydrophilic solvent system may be comprised in droplets, wherein the droplets are preferably stabilized by one or more emulsifying agents.

The continuous phase may comprise a hydrophobic solvent system, the hydrophobic solvent system comprising one or more hydrophobic solvents selected from the group consisting of aliphatic and aromatic hydrocarbons, heterocyclic compounds, and mixtures of two or more thereof. The hydrophobic solvent may comprise aliphatic hydrocarbons comprising one or more of branched and/or unbranched aliphatic (C₄-C₁₂) hydrocarbons, including mixtures of two or more thereof.

In one embodiment, the dispersion provided in step (1) may be formed by a process comprising: (1.a.1) providing a first solution comprising the precursor compound of the first PGM and the precursor compound of the first support a first hydrophilic solvent system; (1.a.2) providing a second solution comprising the precursor compound of the second PGM and the precursor compound of the second support a second hydrophilic solvent system; (1.b) providing a hydrophobic solvent system optionally comprising one or more emulsifying agents; and (1.c) dispersing the first and second solutions in the hydrophobic solvent system by mixing for forming the dispersion. mixing in step (1.c) may be achieved by use of a homogenizer.

Another detailed embodiment provides that the dispersion provided in step (1) is formed by a process comprising: (1.a.1) providing a first dispersion comprising a first disperse phase and a first continuous phase, the first dispersion comprising (a); and (1.a.2) providing a second dispersion comprising a second disperse phase and a second continuous phase, the second dispersion comprising (b). The first and second dispersions provided in steps (1.a.1) and (1.a.2) may be formed by a process comprising: providing a first solution comprising the precursor compound of the first PGM and the precursor compound of the first support a first hydrophilic solvent system and dispersing by mixing the first solution into a first hydrophobic solvent system optionally comprising one or more emulsifying agents; and providing a second solution comprising the precursor compound of the second PGM and the precursor compound of the second support a second hydrophilic solvent system dispersing by mixing the second solution into a second hydrophobic solvent system optionally comprising one or more emulsifying agents.

The hydrophobic solvent system(s) may independently comprise one or more emulsifying agents that are ionic surfactants, nonionic surfactants, or mixtures thereof. The emulsifying agents may comprise a nonionic surfactant that is selected from the group consisting of (C₈-C₂₂) alcohols, (C₆-C₂₀) alcohol ethoxylates with 1 to 8 ethylene oxide units, (C₆-C₂₀) alkyl polyglycosides, polyoxyethylene glycol alkyl ethers, polyoxypropylene glycol alkyl ethers, glucoside alkyl ethers, polyoxyethylene glycol alkylphenol ethers, glycerol alkyl esters, sorbitan alkyl esters, polyoxyethylene glycol sorbitan alkyl esters, cocamide monoethanolamine, cocamide diethanolamine, dodecyldimethylamine oxide, block copolymers of polyethylene glycol and polypropylene glycol, polyethoxylated tallow amine, and mixtures of two or more thereof.

The one or more nonionic surfactants may be selected from the group consisting of (C₁₆-C₁₈)alcohols, (C₁₆-C₁₈)alcohol ethoxylates with 2 to 6 ethylene oxide units, (C₈-C₁₄)alkyl polyglycosides, preferably cetyl alcohol, stearyl alcohol, oleyl alcohol, and mixtures of two or more thereof, octaethylene glycol monododecyl ether and/or pentaethylene glycol monododecyl ether, polyoxypropylene glycol alkyl ethers, decyl glucoside, lauryl glucoside, myristil glucoside, octyl glucoside, polyoxyethylene glycol octylphenol ethers, nonoxynol-9, glyceryl laurate, polyglycerol polyricinoleate, sorbitan monolaurate, sorbitan monopalmitate, sorbitan monostearate, sorbitan oleate, polyoxyethylene (20) sorbitan monolaurate, polyoxyethylene (20) sorbitan monopalmitate, polyoxyethylene (20) sorbitan monostearate, polyoxyethylene (20) sorbitan monooleate, cocamide monoethanolamine, cocamide diethanolamine, dodecyldimethylamine oxide, block copolymers of polyethylene glycol and polypropylene glycol, polyethoxylated tallow amine, Stearyl-EO₂, polyglyceryl-2-dipolyhydroxystearate, polyglyceryl-distearate, C13/15-PEG₃, C13-PEG₂, glyceryl monooleate, C16/18-PEG₂, oleyl-PEG₂, PEG₂₀-sorbitan monooleate, functionalized polyisobutene, C16/18-PEG₉, and mixtures of two or more thereof.

The one or more emulsifying agents may be contained in the dispersion in an amount of from 0.01 to 20 wt.-% based on the total weight of the dispersion provided in step (1).

The average droplet particle size D50 of the disperse phase may be in the range of from 0.05 to 20 μm.

The dispersion may further comprise one or more rare earth oxides other than ceria in the same phase as (a) and/or (b), the rare earth oxides being selected from the group consisting of lanthana, praseodymia, neodymia, and mixtures of two or three thereof.

The concentration of the disperse phase in the dispersion provided in step (1) may be comprised in the range of from 1 to 80 wt.-% based on the total weight of the dispersion.

The one or more precursor compounds of the first PGM, the first support, the second PGM, and/or the second support comprise one or more salts.

The dispersion provided in step (1) may comprise the first and second PGMs in an amount ranging from 0.001 to 10 wt.-% calculated as the metal based on the total weight of the dispersion provided in step (1).

The pyrolysis in step (3) may be performed in an atmosphere containing oxygen. The pyrolysis in step (3) may performed at a temperature comprised in the range of from 600 to 4,000° C.

Also provided are particles of catalytic material obtainable and/or obtained by any process provided herein. Specifically, particles of catalytic material obtainable from flame spray pyrolysis may comprise at least two platinum group metals (PGMs), alumina, ceria and/or zirconia, and optionally one or more oxides of one or more alkaline earth metals or of rare earth elements other than ceria. The average size of the particles of the catalytic material may be in the range of from 5 nm to 1 μm.

The particles catalytic material may comprise by weight of the catalytic material, alumina in the range of from 1 to 50%, ceria in an amount in the range of 1 to 50%, zirconia in an amount in the range of 10 to 70%; and baria and/or strontia in an amount in the range of 1 to 10%; and optionally, yttria, praseodymia, lanthana, neodymia, or combinations thereof in an amount in the range of 0 to 20%. The particles catalytic material may comprise palladium in an amount that is 1.5% by weight of the amount of ceria and/or zirconia and rhodium in an amount that is 0.3% by weight of the amount of alumina.

Also provided is use of the particles of catalytic material according to any embodiment herein as a catalyst for treating an exhaust stream of a combustion engine.

Methods of treating an exhaust stream of a combustion engine are provided, the method comprising supporting the particles of catalytic material of any embodiment on a carrier to form a catalyst composite and passing the exhaust stream through the catalyst composite. The supporting step may comprise forming a washcoat comprising the catalytic material slurried in water and coating the washcoat onto the carrier.

### BRIEF DESCRIPTION OF THE DRAWINGS

The disclosure may be more completely understood in consideration of the following detailed description of various embodiments of the disclosure in connection with the accompanying drawings, in which:

FIG. 1 provides an burner configuration (top and side view) of an exemplary apparatus for flame spray pyrolysis.

### DETAILED DESCRIPTION

Emission control catalysts containing more than one support material and more than one platinum group metal (PGM), such as three-way conversion (TWC) catalysts may be obtained in one-step using flame spray pyrolysis, also referred to as flame synthesis, of specifically-designed dispersions/emulsion. Formation of mixed oxide particles of ceria, zirconia, rare earth oxides other than ceria, and optionally yttria has been demonstrated by the use of flame synthesis of a dispersion has been demonstrated in U.S. Ser. No. 61/836,183, filed Jun. 18, 2013, with common inventor and owner, and incorporated herein by reference in its entirety.

Without intending to be bound by theory, it is understood that upon flame synthesis, the primary crystals are formed in substantially similar size range (10-20 nm). The particles interestingly, however, depending on the solvent system, will significantly differ in their secondary structure and have different particle sizes and specific surface areas. Thus, different structuring of the complex three-way conversion (TWC) catalyst mixture may be adjusted by selection of the appropriate phases of the dispersion or emulsion. This results in different porosities of the overall system, which can be beneficial for the overall performance of the TWC catalyst.

Dispersions or emulsions have at least two distinct phases—a continuous phase and a dispersed phase typically of liquid droplets. The two distinct phases are usually a polar phase and a non-polar phase. As desired, the different phases, polar/hydrophilic and non-polar/hydrophobic, may be used to dissolve or disperse and deliver various ingredients of catalytic material to the pyrolysis step. That is, desired materials may be in either the dispersed or continuous phase, or various different materials may be in both the dispersed and continuous phases. In some embodiments, it may further be possible to provide multiple, different dispersed phases, that is without limitation, a first dispersed phase may have droplets of one composition and a second dispersed phase may have droplets of a different composition and so on. Polar phases commonly include, but are not limited to the use of water or acetic acid. Non-polar phases commonly include, but are not limited to the use of xylene or toluene.

Homogeneously distributed droplets can be produced with a defined size distribution as provided by, for example, microreactors. This approach allows the use of inexpensive inorganic precursors, which are well soluble in water, for example. With the use of flame synthesis, the emulsions are sprayed and oxidized and catalytically active materials are generated directly. At constant size of the primary (about 10-15 nm) particles, the secondary structure depends on the droplet size of the emulsion.

The following terms shall have, for the purposes of this application, the respective meanings set forth below.

“Platinum group metal (PGM) components” refer to platinum group metals or their oxides.

“Precursor compound” refers to a compound that delivers a desired ingredient. For example, water-soluble salts may be desired for delivery of PGMs and other materials such as alumina, cerium, zirconium, barium, and the like. Likewise, organically-based salts for delivery of materials may also be desirable.

“BET surface area” has its usual meaning of referring to the Brunauer-Emmett-Teller method for determining surface area by N₂-adsorption measurements. Unless otherwise stated, “surface area” refers to BET surface area.

“Rare earth metal oxides” refer to one or more oxides of scandium, yttrium, and the lanthanum series defined in the Periodic Table of Elements.

“Washcoat” is a thin, adherent coating of a catalytic or other material applied to a refractory substrate, such as a honeycomb flow through monolith substrate or a filter substrate, which is sufficiently porous to permit the passage there through of the gas stream being treated. A “washcoat layer,” therefore, is defined as a coating that is comprised of support particles. A “catalyzed washcoat layer” is a coating comprised of support particles impregnated with catalytic components.

“TWC catalysts” comprise one or more platinum group metals (e.g., platinum, palladium, rhodium, rhenium and iridium) disposed on a support, which can be a mixed metal oxide as disclosed herein or a refractory metal oxide support, e.g., a high surface area alumina coating. The support is carried on a suitable carrier or substrate such as a monolithic carrier comprising a refractory ceramic or metal honeycomb structure, or refractory particles such as spheres or short, extruded segments of a suitable refractory material. The refractory metal oxide supports may be stabilized against thermal degradation by materials such as zirconia, titania, alkaline earth metal oxides such as baria, calcia or strontia or, most usually, rare earth metal oxides, for example, ceria, lanthana and mixtures of two or more rare earth metal oxides. For example, see U.S. Pat. No. 4,171,288 (Keith). TWC catalysts are formulated to include an oxygen storage component.

“Support” in a catalyst washcoat layer refers to a material that receives precious metals, stabilizers, promoters, binders, and the like through association, dispersion, impregnation, or other suitable methods. Examples of supports include, but are not limited to, high surface area refractory metal oxides and composites containing oxygen storage components such as the mixed metal oxides disclosed herein. The high surface area refractory metal oxide supports preferably display other porous features including but not limited to a large pore radius and a wide pore distribution. As defined herein, such metal oxide supports exclude molecular sieves, specifically, zeolites. High surface area refractory metal oxide supports, e.g., alumina support materials, also referred to as “gamma alumina” or “activated alumina”, typically exhibit a BET surface area in excess of 60 square meters per gram (“m²/g”), often up to about 200 m²/g or higher. Such activated alumina is usually a mixture of the gamma and delta phases of alumina, but may also contain substantial amounts of eta, kappa and theta alumina phases. Refractory metal oxides other than activated alumina can be used as a support for at least some of the catalytic components in a given catalyst. For example, bulk ceria, zirconia, alpha alumina and other materials are known for such use. Although many of these materials suffer from the disadvantage of having a considerably lower BET surface area than activated alumina, that disadvantage tends to be offset by a greater durability of the resulting catalyst.

In the present disclosure, “%” refers to “wt. %” or “mass %”, unless otherwise stated.

A “carrier” of catalytic material is a structure that is suitable for withstanding conditions encountered in exhaust streams of combustion engines. A carrier is a ceramic or metal honeycomb structure having fine, parallel gas flow passages extending from one end of the carrier to the other. The passages may be flow through or they may be alternately blocked as wall-flow filter substrates.

### Dispersions

There is no particular restriction with respect to the type of dispersion or emulsion, the terms are used interchangeably, that may be provided, nor with respect to the method by which the dispersion has been made. Thus, in principle, any suitable dispersion comprising one or more dispersed phases and a continuous phase may be provided in step (1), where the dispersion contains: (a) a precursor compound of a first platinum group metal (PGM) and a precursor compound of a first support, and (b) a precursor compound of a second platinum group metal (PGM) and a precursor compound of a second support, wherein (a) is in a first phase that is different from a second phase containing (b).

The continuous phase may be in the form of a liquid. Furthermore, the disperse phase may be at least partly in the form of a liquid, wherein it is further preferred that the disperse phase according to the inventive process is provided in the form of a liquid in the continuous phase which, preferably, is equally liquid. Thus, both the disperse and the continuous phases provided in step (1) may be liquid. There is no restriction relative to the types of liquid components that may be employed for providing the dispersion provided that the liquid components constitute distinct continuous and disperse phases in the dispersion, either in view of the fact that the liquids per se are not miscible and/or by the aid of specific agents which have been added to the disperse and/or continuous phase for avoiding the admixture thereof to a single phase.

The disperse phase and the continuous phase may be respectively made of liquids that are immiscible or wherein the miscibility of the respective liquids is such that 10 vol.-% or less of either liquid phase may dissolve into the other liquid phase, and preferably 5 vol.-% or less, more preferably 3 vol.-% or less, more preferably 1 vol.-% or less, more preferably 0.5 vol.-% or less, more preferably 0.1 vol.-% or less, more preferably 0.05 vol.-% or less, more preferably 0.01 vol.-% or less, more preferably 0.005 vol.-% or less, and even more preferably 0.001 vol.-% or less of either of the liquid phases may dissolved in the other liquid phase.

As to the relative amounts of the disperse phase and continuous phase of the dispersion provided in step (1), the weight ratio is not particularly restricted provided that the specific steps and parameters chosen in steps (2) and (3) of the inventive process allow for the generation of particles of catalytic material. Thus, by way of example, the concentration of the disperse phase in the dispersion provided in step (1) may be comprised in the range of from 1 to 80 wt.-% based on the total weight of the dispersion, wherein preferably the concentration of the disperse phase is comprised in the range of from 5 to 70 wt.-%, more preferably of from 10 to 60 wt.-%, more preferably of from 20 to 55 wt.-%, more preferably of from 30 to 50 wt.-%, and more preferably of from 35 to 45 wt.-%. According to particularly preferred embodiments of the inventive process, the concentration of the disperse phase in the dispersion provided in step (1) is comprised in the range of from 40 to 42 wt.-% based on the total weight of the dispersion.

The dispersion provided in step (1) may be a water-in-oil dispersion or an oil-in-water dispersion, wherein preferably the dispersion is a water-in-oil dispersion wherein the one or more disperse phases are accordingly of aqueous nature. There is no particular restriction neither with respect to the constituents of the “oil” phase nor with regard to the constituents of the “water” phase such that any conceivable liquids and in particular any conceivable solvent or solvent system may be comprised in the disperse and continuous phases provided that the hydrophobic nature of the “oil” phase is greater than the hydrophobic nature of the “water” phase, and accordingly the hydrophilic nature of the “oil” phase is lower than the hydrophilic nature of the “water” phase. In particular, it is noted that according to the present invention, the words “water” and “oil” as respectively employed in the terms “oil-in-water” and “water-in-oil” relative to specific types of preferred dispersion employed in the inventive process only specifies the hydrophilic character of the disperse phase being greater than the hydrophilic character of the continuous phases in the case of “water-in-oil” dispersions and vice versa a hydrophobic character of the disperse phase being greater than the hydrophobic character of the continuous phase in the case of “oil-in-water” dispersions”. Thus the “water” and “oil” as employed in these terms do not by any means further limit the disperse and continuous phases to a greater extent, in particular with respect to the components which may be contained in the respective phases.

There is no particular restriction as to the solvent or solvent system of the one or more disperse phases that may be contained therein provided that the disperse phase(s) do not admix with the continuous phase of the dispersion. The disperse phase(s) may comprise a hydrophilic solvent system, which may accordingly contain one or more hydrophilic solvents. In this respect, it is noted that the term “hydrophilic” as employed in the present application denotes a hydrophilic character of any one of the solvent systems which may be comprised in the disperse phase as being greater than the hydrophilicity of any of the continuous phases employed in the dispersion provided in step (1). The one or more hydrophilic solvents may be selected from the group of polar solvents. More preferably, the one or more hydrophilic solvents are selected from the group of polar protic and polar aprotic solvents, including mixtures of two or more thereof. Any conceivable solvents or solvent mixtures may be employed for the hydrophilic solvent system of the disperse phase provided that these display respective polar protic and polar aprotic features wherein, preferably, the polar solvents and in particular the polar protic and polar aprotic solvents are selected from the group consisting of alcohols, diols, polyols, ethers, carboxylic acids, formamides, nitriles, sulfoxides, esters of carboxylic acids, ketones, lactones, lactames, sulfones, nitro-compounds, alkyl derivates of urea-compounds, water, and mixtures of two or more thereof, more preferably from the group consisting of (C₁-C₅)alcohols, (C₂-C₆)diols, (C₁-C₃)dialkylethers, (C₁-C₅)carboxylic acids, alkyl amides, acetonitrile, dimethylsulfoxide, propylene carbonate, (C₂-C₆)ketones, (C₄-C₇)lactones, (C₄-C₇)lactames, nitromethane, sulfolane, 1,3 dimethyl-3,4,5,6-tetrahydro2(1H)pyrimidinon (tetra methyl urea), dimethylcarbonate, ethylene carbonate, propylene carbonate, water, and combinations of two or more thereof, more preferably from the group consisting of (C₂-C₄)alcohols, (C₂-C₄)diols, (C₂-C₄)ketones, (C₁-C₂)dialkylethers, (C₂-C₄)carboxylic acids, dimethylformamide, acetonitrile, dimethylsulfoxide, water, and combinations of two or more thereof, more preferably from the group consisting of ethanol, methanol, propanol, ethylene glycol, 1,3-propanediol, 1,2-propanediol, dimethylether, diethylether, ethylmethylether, acetic acid, propionic acid, acetonitrile, water, and combinations of two or more thereof, more preferably from the group consisting of ethanol, methanol, ethylene glycol, dimethylether, ethylmethylether, acetic acid, acetonitrile, water, and combinations of two or more thereof, more preferably from the group consisting of ethanol, methanol, ethylene glycol, dimethylether, acetonitrile, water, and combinations of two or more thereof, and more preferably from the group consisting of methanol, acetonitrile, water, and combinations of two or more thereof. According to particularly preferred embodiments, the hydrophilic solvent system comprises methanol and/or water, preferably water as the one or more hydrophilic solvents.

As noted above, the disperse and continuous phases of the dispersion provided in step (1) may contain one or more agents for stabilizing the respective phases and in particular for stabilizing the disperse phase either from admixture with the continuous phase and/or from coalescence of the disperse phase wherein in particular a coalescence of the disperse phase is prevented by the use of one or more of such agents. The one or more disperse phases may be comprised in droplets, wherein the disperse phase(s) may comprise a hydrophilic solvent system, preferably being provided in droplets form. There is no particular restriction as to the agent or agents which may be employed for stabilizing the droplets such that any suitable surfactant may be employed to this effect provided that a dispersion containing such droplets may be provided in step (1) depending on the liquids and/or solvent systems employed for the disperse and continuous phases of the dispersion. The droplets may be stabilized by one or more emulsifying agents.

There is no particular restriction as to the one or more emulsifying agents that may be employed herein provided that a dispersion comprising a disperse phase and a continuous phase may be obtained. Thus, by way of example, the one or more emulsifying agents may be selected from the group consisting of ionic and nonionic surfactants, as well as from mixtures of one or more ionic surfactants with one or more nonionic surfactants. The ionic surfactants may comprise one or more anionic surfactants. Independently thereof or in addition thereto, the ionic surfactants may comprise one or more cationic surfactants, wherein independently thereof or in addition thereto the ionic surfactants may comprise one or more zwitterionic surfactants. According to particularly preferred embodiments, the one or more emulsifying agents comprise one or more nonionic surfactants.

There is no particular restriction with respect to the type or to the number of nonionic surfactants that may be employed. Thus, by way of example, the nonionic surfactants may be selected from the group consisting of (C₈-C₂₂)alcohols, (C₆-C₂₀)alcohol ethoxylates with 1 to 8 ethylene oxide units, (C₆-C₂₀)alkyl polyglycosides, polyoxyethylene glycol alkyl ethers, polyoxypropylene glycol alkyl ethers, glucoside alkyl ethers, polyoxyethylene glycol alkylphenol ethers, glycerol alkyl esters, sorbitan alkyl esters, polyoxyethylene glycol sorbitan alkyl esters, cocamide monoethanolamine, cocamide diethanolamine, dodecyldimethylamine oxide, block copolymers of polyethylene glycol and polypropylene glycol, polyethoxylated tallow amine, and mixtures of two or more thereof, wherein more preferably the one or more nonionic surfactants are selected from the group consisting of (C₁₄-C₂₀)alcohols, (C₈-C₁₈)alcohol ethoxylates with 2 to 6 ethylene oxide units, (C₈-C₁₈)alkyl polyglycosides, octaethylene glycol mono-dodecyl ether and/or pentaethylene glycol monododecyl ether, polyoxypropylene glycol alkyl ethers, decyl glucoside, lauryl glucoside, myristil glucoside, octyl glucoside, polyoxyethylene glycol octylphenol ethers, preferably triton X-100, nonoxynol-9, glyceryl laurate, polyglycerol polyricinoleate, sorbitan monolaurate, sorbitan monopalmitate, sorbitan monostearate, sorbitan monooleate, polyoxyethylene sorbitan monolaurate, polyoxyethylene sorbitan monopalmitate, polyoxyethylene sorbitan monostearate, polyoxyethylene sorbitan monooleate, cocamide monoethanolamine, cocamide diethanolamine, dodecyldimethylamine oxide, block copolymers of polyethylene glycol and polypropylene glycol, polyethoxylated tallow amine, and mixtures of two or more thereof, wherein more preferably the one or more nonionic surfactants are selected from the group consisting of (C₁₆-C₁₈)alcohols, (C₁₆-C₁₈)alcohol ethoxylates with 2 to 6 ethylene oxide units, (C₈-C₁₄)alkyl polyglycosides, preferably cetyl alcohol, stearyl alcohol, oleyl alcohol, and mixtures of two or more thereof, octaethylene glycol monododecyl ether and/or pen-taethylene glycol monododecyl ether, polyoxypropylene glycol alkyl ethers, decyl glucoside, lauryl glucoside, myristil glucoside, octyl glucoside, polyoxyethylene glycol octylphenol ethers, nonoxynol-9, glyceryl laurate, polyglycerol polyricinoleate, sorbitan monolaurate, sorbitan monopalmitate, sorbitan monostearate, sorbitan oleate, polyoxyethylene (20) sorbitan monolaurate, polyoxyethylene (20) sorbitan monopalmitate, polyoxyethylene (20) sorbitan monostearate, polyoxyethylene (20) sorbitan monooleate, cocamide monoethanolamine, cocamide diethanolamine, dodecyldimethylamine oxide, block copolymers of polyethylene glycol and polypropylene glycol, polyethoxylated tallow amine, Stearyl-EO2, polyglyceryl-2-dipolyhydroxystearate, polyglyceryl-distearate, C13/15-PEG₃, C13-PEG₂, glyceryl monooleate, C16/18-PEG₂, oleyl-PEG₂, PEG₂₀-sorbitan monooleate, functionalized polyisobutene, C16/18-PEG₉, and mixtures of two or more thereof, and more preferably from the group consisting of polyglyceryl-2-dipolyhydroxystearate, diglyceryl-distearate, triglyceryl-distearate, C13/15-PEG₃, C13-PEG₂, glyceryl monooleate, sorbitan monooleate, polyglycer-ol-3-polyricinoleate, C16/18-PEG₂, oleyl-PEG₂, PEG20-sorbitan monooleate, functionalized polyisobutene, C16/18-PEG₉, and mixtures of two or more thereof. According to particularly preferred embodiments, the one or more preferred nonionic surfactants employed as the emulsifying agent is selected from the group consisting of polyglyceryl-2-dipolyhydroxystearate, diglyceryl-distearate, triglyceryl-distearate, and mixtures of two or more thereof, wherein it is even more preferred that the nonionic surfactant comprises polyglycerol-3-polyricinoleate.

As to the one or more ionic surfactants that may be utilized as one or more emulsifying agents, there is no particular restriction as to the ionic surfactants which may be employed to this effect, provided that they are suitable for the formation and/or stabilization of the droplets of the hydrophilic solvent system of the disperse phase comprised in the dispersion provided in step (1) and are in particular suitable for the dispersion of a solution comprising the one or more precursor compounds of platinum group metals and supports in the hydrophobic solvent system preferably by emulsification according to step (1.c). The one or more ionic surfactants may comprise any one or more of an anionic surfactant, of a cationic surfactant, and/or of a zwitterionic surfactant. The one or more anionic surfactants may be selected from the group consisting of salts of (C₆-C₁₈)sulfate, (C₆-C₁₈)ethersulfate, (C₆-C₁₈)sulfonate, (C₆-C₁₈)sulfosuccinate, (C₆-C₁₈)phosphate, (C₆-C₁₈)carboxylate, and mixtures of two or more thereof, more preferably from the group consisting of salts of (C₈-C₁₆)sulfate, (C₈-C₁₆)ethersulfate, (C₈-C₁₆)sulfonate, (C₈-C₁₆)sulfosuccinate, (C₈-C₁₆)phosphate, (C₈-C₁₆)carboxylate, and mixtures of two or more thereof, more preferably from the group consisting of salts of (C₁₀-C₁₄)sulfate, (C₁₀-C₁₄)ethersulfate, (C₁₀-C₁₄)sulfonate, (C₈-C₁₄)sulfosuccinate, (C₁₀-C₁₄)phosphate, (C₁₀-C₁₄)carboxylate, and mixtures of two or more thereof, and more preferably from the group consisting of salts of laurylsulfate, laurylsulfonate, dioctyl sulfosuccinate, laurylphosphate, laurate, and mixtures of two or more thereof. As to the counterions to the anionic surfactants which may employed, any suitable counterion or combination of counterions may be employed. According to preferred embodiments, however, the counterion is selected from the group consisting of H+, alkali metals, alkaline earth metals, ammonium, and combinations of two or more thereof, more preferably from the group consisting of H+, Li+, Na+, K+, ammonium, and combinations of two or more thereof, more preferably from the group consisting of Na+, K+, ammonium, and combinations of two or more thereof, wherein even more preferably the counterion is Na+ and/or ammonium, and preferably Na⁺.

Concerning the one or more cationic surfactants as the one or more emulsifying agents, again no particular restrictions apply in their respect neither regarding the type of one or more cationic surfactants which may be employed, nor with respect to the number of different cationic surfactants which may be possibly used in combination. Thus, by way of example, the one or more cationic surfactants may be selected from the group consisting of primary, secondary, tertiary, and quaternary ammonium compounds, including mixtures of two or more thereof, wherein more preferably the cationic surfactants comprise one or more quaternary ammonium compounds, preferably selected from the group consisting of salts of (C₈-C18)trimethylammonium, (C₈-C₁₈)pyridinium, benzalkonium, benzethonium, dimethyldioctade-cylammonium, cetrimonium, dioctadecyldimethylammonium, and mixtures of two or more thereof, and more preferably from the group consisting of salts of cetyltrimethylammonium, do-decyltrimethylammonium, cetylpyridinium, benzalkonium, benzethonium, dimethyldioctade-cylammonium, cetrimonium, dioctadecyldimethylammonium. Regarding the counterions to the cationic surfactants which may employed in the aforementioned preferred embodiments of the inventive process, any suitable counterion or combination of counterions may be employed. According to preferred embodiments, however, the counterion is selected from the group consisting of halides, carbonates, hydroxide, nitrate, phosphate, sulfate, and combinations of two or more thereof, more preferably from the group consisting of chloride, fluoride, bromide, hydrogen carbonate, hydroxide, nitrate, sulfate, and combinations of two or more thereof, wherein more preferably the counterion is chloride and/or nitrate, and preferably chloride.

Finally, among the ionic surfactants, one or more zwitterionic surfactants may be equally be contained therein, wherein again no particular restrictions apply neither with respect to the type nor with respect to the number of different zwitterionic surfactants which may be employed. The one or more zwitterionic surfactants may comprise one or more betaines and more preferably one or more betaines including cocoamidopropyl betaine or alkyldimethylamine oxide.

The amount of the emulsifying agent contained in the dispersion may range anywhere from 0.01 to 20 wt. % based on the total weight of the dispersion provided in step (1). The emulsifying agent may be contained in the dispersion in an amount of from 0.05 to 10 wt. %, and more preferably of from 0.1 to 7.0 wt. %, more preferably from 0.5 to 5.0 wt. %, more preferably from 0.8 to 4.0 wt. %, more preferably from 1 to 3.0 wt. %, more preferably from 1.3 to 2.5 wt. %, more preferably from 1.5 to 2.0 wt. %, and even more preferably from 1.7 to 1.9 wt. %.

Regarding the continuous phase, there is again no particular restriction as to the components that may be contained therein, provided that they form a separate phase to the one or more disperse phases and accordingly do not admix with the disperse phase(s) provided in the dispersion. According to specific embodiments, the disperse phase comprises a hydrophilic solvent system and the continuous phase comprises a hydrophobic solvent system. Within the meaning of the present application, the term “hydrophobic” relative to the solvent system of the continuous phase indicates that the hydrophobicity of the solvent system is greater than the hydrophobicity of the disperse phase depending on the liquid components and in particular depending on the solvent system that is employed for the disperse phase. The continuous phase may comprise one or more hydrophobic solvents thus forming a hydrophobic solvent system. No particular restriction applies to the one or more hydrophobic solvents that may be employed, provided that a separate continuous phase may be formed in addition to the disperse phase contained in the dispersion. Thus, by way of example, the one or more hydrophobic solvents may be selected from the group of hydrocarbons, wherein it is preferred that the one or more hydrophobic solvents are selected from the group consisting of aliphatic and aromatic hydrocarbons, heterocyclic compounds, and mixtures of two or more thereof, wherein the aliphatic and aromatic hydrocarbons include hydrophobic derivatives of aliphatic and aromatic hydrocarbons such as alcohols or carboxylic acids, and preferably C₈-alcohols, C₈-carboxylic acids, and/or oils. The one or more hydrophobic solvents may be selected from the group consisting of aliphatic and aromatic hydrocarbons, heterocyclic compounds, and mixtures of two or more thereof wherein even more preferably the one or more hydrophobic solvents comprise one or more aliphatic hydrocarbons.

The aliphatic hydrocarbons may comprise one or more of the hydrophobic solvents in the hydrophobic solvent system of the continuous, any conceivable aliphatic hydrocarbons may be employed wherein the aliphatic hydrocarbons may principally be branched or unbranched. The group of aliphatic hydrocarbons from which the one or more hydrophobic solvents may be selected preferably comprises one or more selected from branched and/or unbranched, preferably unbranched aliphatic (C₄-C₁₂)hydrocarbons, including mixtures of two or more thereof, preferably aliphatic (C₅-C₁₀)hydrocarbons, more preferably aliphatic (C₆-C₈)hydrocarbons, more preferably aliphatic (C₆-C₇)hydrocarbons, and even more preferably one or more selected from branched and/or unbranched, preferably unbranched aliphatic C₆-hydrocarbons, wherein even more preferably the group of aliphatic hydrocarbons comprises one or more selected from pentane, hexane, heptane, octane, and mixtures of two or more thereof. According to particularly preferred embodiments of the inventive process, the hydrophobic solvent system comprises pentane and/or hexane as the one or more hydrophobic solvents, and preferably comprises hexane.

Concerning the group of aromatic hydrocarbons from which the one or more hydrophobic solvents contained in the hydrophobic solvent system, there is again no particular restriction as to the aromatic hydrocarbons which may be contained therein, wherein preferably the group of aromatic hydrocarbons comprises one or more selected from aromatic (C₆-C₁₂)hydrocarbons, including mixtures of two or more thereof, preferably aromatic (C₇-C₁₁)hydrocarbons, more preferably aromatic (C₈-C₁₀)hydrocarbons, more preferably aromatic (C₈-C₉)hydrocarbons, and even more preferably aromatic C₈-hydrocarbons, wherein even more preferably the group of aromatic hydrocarbons comprises one or more selected from toluene, ethylbenzene, xylene, mesitylene, durene, and mixtures of two or more thereof, and more preferably from toluene, ethylbenzene, xylene, and mixtures of two or more thereof. According to particularly preferred embodiments, the hydrophobic solvent system comprises toluene and/or xylene as the one or more hydrophobic solvents, and preferably comprises xylene.

Finally, regarding the heterocyclic compounds, again no particular restriction applies in their respect such that any suitable heterocyclic compounds may be employed. The one or more heterocyclic compounds may comprise one or more of N- and O-containing heterocycles, including mixtures of two or more thereof, and more preferably one or more selected from pyrrolidine, pyrrole, piperidine, pyridine, azepane, azepine, tetrahydrofurane, and mixtures of two or more thereof.

Besides the aforementioned characteristics of the dispersion provided in step (1) in particular relative to the type and amount of its constituents, there is no particular restriction relative to the further characteristics of the dispersion provided that it may be suitably employed for the formation of an aerosol in step (2) of the inventive process. This applies in particular relative to the grade of dispersion achieved by the disperse phase contained in the dispersion which is primarily related by the droplet particle size and droplet particle size distribution of a given dispersion. Thus, regarding the average particle size of the dispersion and in particular of the droplets of the disperse phase contained in the continuous phase of the dispersion, no particular restriction applies in this respect such that, by way of example, the average droplet particle size D50 of the disperse phase may be comprised in the range of anywhere from 0.05 to 20 μm. According to preferred embodiments, however, the dispersion provided in step (1) displays an average droplet particle size D50 comprised in the range of from 0.1 to 15 μm, and more preferably of from 0.2 to 10 μm, more preferably of from 0.5 to 9 μm and more preferably of from 1 to 5 μm. According to particularly preferred embodiments of the inventive process, the average droplet particle size of D50 of the disperse phase provided in step (1) is comprised in the range of from 2 to 4 μm.

Same applies accordingly relative to the droplet particle size distribution displayed by the dispersion provided in step (1) such that any conceivable particle size distribution may be employed relative to the particles and in particular to the droplets contained in the dispersion. Thus, by way of example, the D90 values which may be displayed by the dispersion provided in step (1) may be comprised in the range of anywhere from 0.1 to 50 μm. It is preferred that the D90 value of the disperse phase provided in step (1) is comprised in the range of from 0.5 to 30 μm and more preferably of from 1 to 22 μm, more preferably of from 2 to 16 μm, and more preferably of from 3 to 8 μm. According to particularly preferred embodiments of the inventive process, the disperse phase provided in step (1) displays a D90 value comprised in the range of from 4 to 6 μm.

As employed herein, the average particle droplet size value D50 indicates that considering the sizes of all droplet particles, i.e. the cumulative droplet particle size distribution, 50 wt.-% thereof have sizes less than the indicated D50 value. Same applies accordingly relative to the D90 values indicating that 90 wt.-% of the droplet particles have a smaller particle size than the indicated value for D90, as well as for the D10 values defined in the present application which accordingly indicate that 10 wt.-% of the particles have a smaller droplet particle size than the indicated D10 value. Furthermore, the term “particle droplet size” refers to the diameter of a droplet particle and preferably to its average diameter. According to a definition which is alternatively preferred, the term “droplet particle diameter” refers to the largest diameter, i.e. to the largest dimension of the droplet particle.

Concerning the dispersion provided in step (1), there is no particular restriction with respect to the amount or type of the one or more precursor compounds of materials, for example, the at two least platinum group metals (PGM), alumina, ceria, and/or zirconia, optionally one or more oxides of one or more alkaline earth metals or of rare earth elements other than ceria, provided that depending on the specific parameters and conditions which are employed in the steps of providing the dispersion in step (1), of forming the aerosol from said dispersion in step (2), and of pyrolyzing the aerosol in step (3), particles of catalytic material are obtained.

Concerning the one or more precursor compounds of any desired materials in the dispersion provided in step (1), there is no particular restriction neither with respect to the particular type or number of precursor compounds which may be employed nor with respect to the amount in which they may be provided in the dispersion provided that depending on the further components provided in the dispersion and the specific means of executing steps (1), (2) and (3) of the inventive process affords particles of catalytic material in step (3). As to types of precursor components for any desired material, any conceivable salts may be employed, wherein it is preferred that the one or more salts may completely dissolve in the disperse phase provided in step (1), wherein the type of salts chosen may accordingly depend on the type and amount of salts chosen for the other precursor compounds provided in step (1) and in particular on the further components of the disperse phase and in particular on the hydrophilic solvent system and/or on the one or more emulsifying agents preferably comprised in the disperse phase according to any of the particular and preferred embodiments of the inventive process. It is particularly preferred that the one or more precursor compounds comprise one or more salts selected from the group consisting of nitrates, nitrites, halides, sulfates, sulfites, phosphates, carbonates, hydroxides, carboxylates, alcoholates, and mixtures of two or more thereof, more preferably from the group consisting of nitrates, fluorides, chlorides, bromides, hydrogensulfates, hydrogenphosphates, dihydrogenphosphates, hydrogencarbonates, hydroxides, (C₆-C₁₀)carboxylates, (C₂-C₅) alcoholates, and mixtures of two or more thereof, more preferably from the group consisting of nitrates, chlorides, bromides, hydrogensulfates, dihydrogenphosphates, hydroxides, (C₇-C₉)carboxylates, (C₃-C₄)alcoholates, and mixtures of two or more thereof, more preferably from the group consisting of nitrates, chlorides, hydrogensulfates, hydroxides, C₈-carboxylates, C₃-alcoholates, and mixtures of two or more thereof. According to particularly preferred embodiments, the salts are selected from nitrates and/or chlorides, wherein even more preferably the one or more precursor compounds comprise one or more nitrates.

It is further preferred with respect to the one or more precursor compounds comprising one or more salts, that the salts do not lower the solubility of the one or more further precursor compounds as a result of the specific type of salt which is used. Furthermore, it is preferred that the salts which are preferably used as the one or more precursor compounds do not have a negative impact on the apparatus which is used and in particular does not generate reactive side products which may damage said apparatus, e.g., by corrosion thereof. Accordingly, the dispersion provided in step (1) typically does not contain any halides and in particular does not contain any fluorides, chlorides, and/or bromides. The dispersion provided in step (1) does not contain any halides when no substantial amount of a halide-containing salt is present in the dispersion provided in step (1), wherein the term “substantial” as employed for example in the terms “substantially not”, or “not any substantial amount of” within the meaning of the present invention respectively refer to there practically being not any amount of said component in the dispersion provided in step (1) and/or in the aerosol formed in step (2) of the inventive process, wherein preferably 0.1 wt.-% or less of said one or more components is contained therein based on the total weight of the mixture and/or of the liquids and/or solids contained in the aerosol, preferably an amount of 0.05 wt.-% or less, more preferably of 0.001 wt.-% or less, more preferably of 0.0005 wt.-% or less, and even more preferably of 0.0001 wt.-% or less.

The at least two platinum group metals (PGMs) are selected from the group consisting of Ru, Rh, Pd, Os, Ir, Pt, and mixtures of three or more thereof, more preferably from the group consisting of Rh, Pd, Pt, and mixtures of two or more thereof. Each of the at least two PGMs may be included in the dispersion provided in step (1) in an amount ranging anywhere from 0.001 to 5 wt.-% calculated as the metal based on the total weight of the dispersion provided in step (1), wherein preferably the amount thereof is comprised in the range of from 0.003 to 2 wt.-%, more preferably of from 0.005 to 1 wt.-%, more preferably of from 0.008 to 0.5 wt.-%, more preferably of from 0.01 to 0.3 wt.-%, more preferably of from 0.03 to 0.2 wt.-%, and more preferably of from 0.05 to 0.15 wt.-%. With specific respect to PGMs, nitrate salts such as palladium nitrate, rhodium nitrate, and/or platinum nitrate are exemplary precursors. It may also be desirable to use organic metal salts such as acetylacetonates of PGM.

The alumina may be provided as a salt or a suspension of nano-sized alumina particles. The suspension of particles may comprise aluminum oxide, aluminum hydroxide, aluminum oxyhydroxide, or a mixture thereof. Anions such as nitrate, acetate and formate may coexist in a colloidal alumina suspension. In one or more embodiments, the colloidal alumina is suspended in deionized water in solids loadings in the range of 5% to 50% by weight. Specific salts of alumina may include, but are not limited to, alumina nitrate or alumina alkoxides, oxy-hydroxides, hydroxides, acetylacetonates, or carboxylates, depending on the phase for delivery. The concentration of the one or more precursor compounds of alumina may be comprised in the range of from 0.05 to 50 wt.-%, or 0.1 to 40 wt.-%, more preferably of from 0.5 to 20 wt.-%, more preferably of from 1 to 10 wt.-% based on the total weight of the dispersion provided in step (1).

The precursor compounds of ceria may include ceria nitrate. Concentration of the ceria precursors that may be contained in the dispersion provided in step (1) calculated as CeO₂ contained in the dispersion provided in step (1) may be comprised anywhere in the range of from 0.05 to 15 wt.-% based on the total weight of the dispersion provided in step (1), wherein preferably the concentration of the one or more precursor compounds of ceria is comprised in the range of from 0.1 to 10 wt.-%, more preferably of from 0.5 to 5 wt.-%, more preferably of from 0.8 to 3 wt.-%, more preferably of from 1 to 2.5 wt.-%, and more preferably of from 1.4 to 2.2 wt.-%.

The precursor compounds of zirconia may include zirconia nitrate. Concerning the one or more precursor compounds of zirconia provided in step (1) of the inventive process, the concentration of the one or more precursor compounds of zirconia calculated as ZrO₂ contained in the dispersion provided in step (1) may be comprised in the range of from anywhere from 0.05 to 15 wt.-% based on the total weight of the dispersion provided in step (1), wherein preferably the concentration of the one or more precursor compounds of zirconia is comprised in the range of from 0.1 to 10 wt.-%, more preferably of from 0.5 to 7 wt.-%, more preferably of from 1 to 5 wt.-%, more preferably of from 1.5 to 4 wt.-%, and more preferably of from 1.8 to 3 wt.-%.

One or more alkaline earth metals oxides may comprise one or more of baria, strontia, calcia, and magnesia, including mixtures of two or three thereof, wherein it is further preferred that the one or more alkaline earth metal oxides comprises baria. The concentration of the one or more precursor compounds of the one or more alkaline earth oxides calculated as their respective oxides contained in the dispersion provided in step (1) may be comprised in the range of anywhere from 0.01 to 10 wt.-% based on the total weight of the dispersion provided in step (1), wherein preferably the concentration thereof is comprised in the range of from 0.05 to 5 wt.-%, more preferably from 0.08 to 2 wt.-%, more preferably from 0.1 to 0.1 wt.-%.

One or more rare earth oxides other than ceria may comprise one or more of lanthana, praseodymia, and neodymia, including mixtures of two or three thereof, wherein it is further preferred that the one or more rare earth oxides other than ceria comprise lanthana and/or neodymia, and even more preferably the rare earth oxide other than ceria is lanthana. The concentration of the one or more precursor compounds of the one or more rare earth oxides other than ceria calculated as their respective oxides contained in the dispersion provided in step (1) may be comprised in the range of anywhere from 0.01 to 5 wt.-% based on the total weight of the dispersion provided in step (1), wherein preferably the concentration thereof is comprised in the range of from 0.05 to 2 wt.-%, more preferably from 0.08 to 1 wt.-%, more preferably from 0.1 to 0.5 wt.-%, more preferably from 0.15 to 0.35 wt.-%, and more preferably from 0.18 to 0.3 wt.-%.

The designation of the rare earth oxides does not refer to a particular type thereof, in particular relative to the oxidation state of the rare earth metal, such that any one or more rare earth oxides may be designated. Thus, by way of example, unless otherwise specified, the term “ceria” principally refers to the compounds CeO₂, Ce₂O₃, and any mixtures of the aforementioned compounds. According to a preferred meaning of the present invention, however, the term “ceria” designates the compound CeO₂. Same applies accordingly relative to the term “praseodymia” such that in general said term designates any one of the compounds Pr₂O₃, Pr₆O₁₁, PrO₂, and any mixtures of two or more thereof. According to a preferred meaning of the present invention, the term “praseodymia” designates the compound Pr₂O₃.

### Formation of Particles by Flame Synthesis of Dispersions

The dispersion may be provided as needed, or it may be produced directly prior to step (2) of forming an aerosol with the dispersion. In particular, it may be advantageous to produce the dispersion directly before the forming of an aerosol depending on the stability of the dispersion provided in step (1) which may necessitate its rapid conversion to an aerosol in step (2) for preventing an undesirable coalescence of the disperse phase and/or an equally undesirable admixing of the continuous and disperse phases prior to the formation of an aerosol in step (2) and its subsequent pyrolyzing in step (3).

In one detailed embodiment, where two different disperse phases in one continuous phase are provided, the dispersion in step (1) is formed by a process comprising:

(1.a.1) providing a first solution comprising the precursor compound of the first PGM and the precursor compound of the first support a first hydrophilic solvent system;

(1.a.2) providing a second solution comprising the precursor compound of the second PGM and the precursor compound of the second support a second hydrophilic solvent system;

(1.b) providing a hydrophobic solvent system optionally comprising one or more emulsifying agents;

(1.c) dispersing the first and second solutions in the hydrophobic solvent system by mixing for forming the dispersion.

Regarding the provision of the solutions in steps (1.a.1) and (1.a.2), there is no particular restriction as to the means which are employed for forming the solutions provided that a mixture of the desired PGM and support combination along with a hydrophilic solvent system are provided wherein at least a portion of said one or more precursor compounds may be dissolved in the hydrophilic solvent system. In instances wherein one or more of the precursor compounds is partly insoluble in the hydrophilic solvent system, it is preferred that means of homogenizing the mixture are employed for achieving the dispersion of said insoluble portion of one or more of the precursor compounds which may not be completely dissolved in the hydrophilic solvent system. Thus, the homogenous solutions may be provided by appropriate means of agitation such as by stirring, shaking, rotating, and sonication, wherein preferably a homogenization of the mixture is achieved by appropriate stirring of the insoluble portions of the one or more precursors in the solution for providing a high dispersion thereof. It is preferred that the one or more precursor compounds provided in steps (1.a.1) and (1.a.2) are respectively soluble in the hydrophilic solvent system which is provided such that a homogenous mixture is provided by the solution of all components in said solvent system.

Regarding the provision of a hydrophobic solvent system in step (1.b), there is again no particular restriction in this respect wherein it is however preferred that one or more emulsifying agents are provided together with the hydrophobic solvent system in instances wherein the choice of the hydrophilic and hydrophobic solvent systems does not allow for the formation of a dispersion in the absence of one or more emulsifying agents or in instances wherein a stabilization of the dispersion is desired prior to the formation of an aerosol in step (2), and in particular in instances wherein the delay between the provision of a dispersion in step (1) and the formation of an aerosol in step (2) is such that a stabilization by one or more emulsifying agents becomes desirable or necessary.

Regarding the hydrophilic solvent system which may be provided in step (1.a), the hydrophobic solvent system which may be provided in step (1.b) as well as the one or more emulsifying agents which may be provided in step (1.b), it is preferred that the aforementioned are chosen among any of those as set out in the present description.

Concerning the dispersing of the solution provided in steps (1.a.1) and (1.a.2) in the hydrophobic solvent system provided in step (1.b) in step (1.c), any suitable procedure may be employed for performing the dispersing provided that a dispersion is formed comprising the solution dispersed in the hydrophobic solvent system. Thus, by way of example, the dispersing of the solution in the hydrophobic solvent system may be achieved by use of a homogenizer. The dispersing of the solution in step (1.c) by mixing may be achieved with a rotor-stator homogenizer, with an ultrasonic homogenizer, with a high pressure homogenizer, by microfluidic systems, or by membrane emulsification, wherein even more preferably the dispersing of the solution is achieved by employing a high pressure homogenizer or a rotor-stator homogenizer. According specific embodiments, the mixing in step (1.c) is achieved by use of a rotor-stator homogenizer. The dispersing of the solution in the hydrophobic solvent system in step (1c) may be achieved by emulsification wherein in particular a method of emulsification is employed in step (1.c) wherein one or more emulsifying agents have been provided in step (1.b) in addition to the hydrophobic solvent system.

In another detailed embodiment, where two different dispersions, each comprising its own disperse and continuous phases are provided, the dispersion in step (1) is formed by a process comprising:

(1.a.1) providing a first dispersion comprising a first disperse phase and a first continuous phase, the first dispersion comprising (a); and

(1.a.2) providing a second dispersion comprising a second disperse phase and a second continuous phase, the second dispersion comprising (b).

Further, step (1.a.1) may include providing a first solution comprising the precursor compound of the first PGM and the precursor compound of the first support a first hydrophilic solvent system and dispersing by mixing the first solution into a first hydrophobic solvent system optionally comprising one or more emulsifying agents; and step (1.a.2) may include providing a second solution comprising the precursor compound of the second PGM and the precursor compound of the second support a second hydrophilic solvent system dispersing by mixing the second solution into a second hydrophobic solvent system optionally comprising one or more emulsifying agents.

Concerning the formation of an aerosol in step (2), there is again no particular restriction as to the means that may be employed for forming such an aerosol provided that it may be pyrolyzed in step (3) of the inventive process. Thus, the aerosol may be formed by any appropriate means for dispersing the dispersion provided in step (1) in a gaseous medium such as by spraying the dispersion provided in step (1) into said medium. According to a preferred embodiment, the dispersion provided in step (1) is sprayed into a gas stream for obtaining a stream of said aerosol which may then be conducted into a pyrolyzing zone for achieving step (3) of the inventive process.

As for the step of pyrolyzing of the aerosol provided in step (2), there is again no particular restriction as to the method which is employed for achieving said pyrolysis, provided that at least a portion of the aerosol is converted to particles of catalytic material as a result of the thermal treatment. Thus, by way of example, the pyrolysis in step (3) may be achieved with the aid of any suitable heat source of which the temperature is sufficient for pyrolyzing at least a portion of the aerosol provided in step (2). The process for the production of particles of catalytic material is generally conducted in a continuous mode, wherein the aerosol according may be provided as a gas stream that is allowed to pass a pyrolyzing zone for obtaining particles from at least a portion of said aerosol in the gas stream exiting the pyrolyzing zone. When the pyrolysis is conducted in a continuous mode, there is no particular restriction as to the weight hourly space velocity of the aerosol gas stream that is conducted to the pyroylsing zone, nor is there any restriction as to the extent of the pyrolyzing zone provided that the weight hourly space velocity is chosen such depending on the extent of the pyrolyzing zone at least a portion of the aerosol may be pyrolyzed in step (3) for obtaining particles.

The gas in which the aerosol is formed in step (2) may contain one type of gas or several different types of gases. Accordingly, the gas employed for providing the aerosol in step (2) may consist of one or more inert gases, wherein according to the present invention said one or more inert gases do not react under the conditions of pyrolysis in step (3) of the inventive process. It is preferred that at least a portion of the gas employed for forming an aerosol in step (2) is a gas which reacts with at least a portion of the dispersion provided in step (1), wherein it is further preferred that said gas has an oxidizing effect on the dispersion provided in step (1), in particular during pyrolysis of the mixture in step (3). Under conditions where the portion of the gas contained in the aerosol provided in step (2) has an oxidizing effect on the dispersion provided in step (1) and reacts with at least a portion of the mixture during pyrolysis in step (3), such a reaction is exothermic for providing at least a portion of the heat source required in step (3) for the pyrolysis of the dispersion provided in step (1). According to particularly preferred embodiments, the oxidizing gas comprised in the aerosol in step (2) comprises oxygen, wherein more preferably the oxidizing gas contained in the aerosol of step (2) is air, and more preferably air enriched with oxygen. According to particularly preferred embodiments it is further preferred that the oxidizing gas contained in the aerosol of step (2) is oxygen.

Regarding the pyrolysis performed in step (3), there is no particular restriction as to the temperature at which said step is performed, provided that particles of catalytic material are produced. Thus, by way of example, the temperature at which the pyrolysis is performed may be comprised in the range of anywhere from 600 to 4,000° C., wherein preferably the temperature in step (3) is comprised in the range of from 900 to 3,500° C., more preferably of from 1,000 to 3,000° C., more preferably of from 1,100 to 2,500° C., and more preferably of from 1,150 to 2,000° C. According to particularly preferred embodiments of the present invention, pyrolysis in step (3) is performed at a temperature comprised in the range of from 1,200 to 1,500° C.

Further regarding the pyrolysis in step (3), the preferred temperatures at which said step is performed refers to the temperature of the reaction zone in which pyrolysis takes place and preferably to the average temperature measured therein. Thus, in view of the temperature gradient often formed in the reaction zone in which pyrolysis takes place, the aforementioned preferred temperatures do not necessarily reflect the temperature which may be measured in the hottest region of the reaction zone in which pyrolysis takes place. Concerning the hottest region of the reaction zone in which pyrolysis in step (3) of the inventive process takes place, there is no general restriction as to which temperatures may be employed provided that particles of catalytic material may be formed in said step. Thus, by way of example, the temperature in the hottest region of the reaction zone in which pyrolysis takes place may range anywhere from 400 to 4,000° C., wherein preferably the temperature in the hottest region is comprised in the range of 1,200 to 3,500° C. According to particularly preferred embodiments, the temperature of the hottest region in which pyrolysis in step (3) takes place is comprised in the range of from 1,500 to 3,000° C.

Embodiments are preferred wherein pyrolysis in step (3) is performed in an atmosphere containing oxygen, preferably in air, more preferably in air enriched with oxygen, and even more preferably in an oxygen atmosphere.

According to other embodiments, pyrolysis in step (3) is conducted using a burner configuration in which the pyrolysis of the aerosol is assisted and guided by a pilot flame located in proximity such as to achieve a temperature of pyrolysis. There is no particular restriction as to the type of pilot flame that may be employed herein provided that the desired temperature in the pyrolysis zone may be achieved. Thus, by way of example, the fuel employed for generating the pilot flame is not particularly restricted such that in principle any suitable combustant may be employed. According to preferred embodiments, a combustant is employed that generates little to no carbonaceous residues under the chosen conditions of use. Thus, by way of example, any suitable hydrocarbon may be employed to this effect, wherein preferably short chain saturated and/or unsaturated hydrocarbons with one to three C atoms and preferably with one or two C atoms including mixtures of two or more thereof may be employed as the combustant of the pilot flame. According to particularly preferred embodiments thereof, methane and/or ethylene is employed as the combustant in the pilot flame. Regarding the oxidant used for the combustion of the fuel employed in the pilot flame, again no particular restriction applies provided that a temperature comprised in the particular and preferred ranges of the inventive process may be achieved and that furthermore little to no carbonaceous residues are generated. Thus, by way of example, any gas containing an appropriate oxidizing agent and preferably an oxidizing agent in the form of a gas may be employed, wherein preferably a gas containing oxygen is employed, and more preferably a gas containing one or more inert gases such as nitrogen may be employed for generating the pilot flame. According to particularly preferred embodiments thereof, a mixture of air and oxygen is employed as the oxidizing agent for the combustion of the fuel in the pilot flame, wherein more preferably oxygen gas is used as the oxidizing agent.

With respect to the composition of the aerosol formed in step (2), no particular restriction applies relative to the weight ratio of the dispersion to the dispersing gas in which the aerosol is formed. Thus, by way of example, the weight ratio of the dispersion to the gas phase of the aerosol may range anywhere from 1 to 20, wherein preferably the weight percent ratio of dispersion to gas in the aerosol formed in step (2) is comprised in the range of from 3 to 15, and even more preferably a weight ratio comprised in the range of 8 to 12 is employed in particularly preferred embodiments of the inventive process.

### Particles of Catalytic Material

In addition to providing a process for the production of particles of catalytic material, provided herein are the particles per se that are obtained according to any of the particular and preferred embodiments of the inventive process.

Specifically, provided are particles of catalytic material obtainable from flame spray pyrolysis, wherein the particles comprise at least two platinum group metals (PGMs), alumina, ceria and/or zirconia, and optionally one or more oxides of one or more alkaline earth metals or of rare earth elements other than ceria. An average size of the particles of the catalytic material may be in the range of from 5 nm to 1 μm.

Concerning the catalytic material, there is no particular restriction with respect to content of materials, for example, the at two least platinum group metals (PGM), alumina, ceria, and/or zirconia, optionally one or more oxides of one or more alkaline earth metals or of rare earth elements other than ceria.

The content of the platinum group metals may be provided in any range that is effective to achieve desired oxidation and reduction reactions, such as, for example, oxidation of hydrocarbons (HCs) and/or carbon monoxide (CO) and reduction of nitrogen oxides (NOx).

Alumina may be present in the particles by weight in ranges of 1 to 50%, or 5 to 45%, or 10 to 35%, or even 15 to 30%. Ceria may be present in the particles by weight in ranges of 1 to 50%, or 5 to 45%, or 5 to 35%, or 10 to 30%. Zirconia may be present in the particles by weight in ranges of 10 to 70%, 30 to 60%, or 35-55%. Alkaline earth metal oxides may be present in the particles by weight in the ranges of 1 to 5%. Rare earth oxides other than ceria may be present in the particles by weight in the ranges of anywhere from 0.05 to 30%, or 0.1 to 25 wt. %, more preferably of from 0.5 to 20 wt. %, more preferably of from 1 to 15 wt. %, more preferably of from 2 to 12 wt. %, more preferably of from 3 to 10 wt. %, more preferably of from 3.5 to 8 wt. %, and more preferably of from 4 to 7 wt. %.

The particles of catalytic material are effective for use in oxidative applications, in particular in the field of automotive exhaust gas treatment, and even more particularly as oxidation catalyst and preferably for use in three-way catalysis (TWC) and/or diesel oxidation catalysts (DOC).

It is particularly preferred that the particles of catalytic material according to the present invention display a relative stable BET surface area under ageing condition such that the reduction in said BET surface area after ageing calculated as the difference between the BET surface area values in the fresh and aged states divided by the BET surface area of the fresh material prior to ageing (=[BET fresh−BET aged]/BET fresh) is comprised in the range of from 40 to 90%, and preferably in the range of from 40 to 80%. According to particularly preferred embodiments of the present invention, the reduction in BET surface area after ageing of the material according to the present invention as calculated in the aforementioned fashion lies between 40 and 60%.

Concerning the dimensions of the particles of catalytic material, these may adopt any conceivable values. It is, however, preferred that the are microcrystalline, wherein it is preferred that the average particle size of the particles is comprised in the range of from 1 to 150 nm, and preferably of from 5 to 100 nm, and preferably of from 6 to 50 nm, more preferably of from 7 to 30 nm, more preferably of from 8 to 20 nm, more preferably of from 9 to 18 nm, and more preferably of from 10 to 16 nm. The values of the average particle size as defined in the present application, refer in particular to the average particle size as obtained using the Scherrer formula as follows:

$$τ = \frac{K λ}{β cos θ}$$

wherein K is the shape factor, lambda (λ) is the X-ray wave length, beta (β) is the line broadening at half the maximum intensity (FWHM) in radians, and theta (θ) is the Bragg angle. Tao (τ) stands for the mean size of the ordered (crystalline) domains, which may be smaller or equal to the grain size. The dimensionless shape factor has a typical value of about 0.9, and may be adapted to the actual shape of the crystallite if necessary.

Uses of the particles of catalytic material according to any of the particular or preferred embodiments as defined herein include a catalyst or catalyst component in a three way catalyst and/or diesel oxidation catalyst for the treatment of exhaust gas, preferably of automotive exhaust gas.

### Carriers

In one or more embodiments, a catalytic material is disposed on a carrier. That is, the catalytic material may slurried in water to form a washcoat, which is coated onto the carrier.

The carrier may be any of those materials typically used for preparing catalyst composites, and will preferably comprise a ceramic or metal honeycomb structure. Any suitable carrier may be employed, such as a monolithic substrate of the type having fine, parallel gas flow passages extending therethrough from an inlet or an outlet face of the substrate, such that passages are open to fluid flow therethrough (referred to as honeycomb flow through substrates). The passages, which are essentially straight paths from their fluid inlet to their fluid outlet, are defined by walls on which the catalytic material is coated as a washcoat so that the gases flowing through the passages contact the catalytic material. The flow passages of the monolithic substrate are thin-walled channels, which can be of any suitable cross-sectional shape and size such as trapezoidal, rectangular, square, sinusoidal, hexagonal, oval, circular, etc. Such structures may contain from about 60 to about 900 or more gas inlet openings (i.e., cells) per square inch of cross section.

The carrier can also be a wall-flow filter substrate, where the channels are alternately blocked, allowing a gaseous stream entering the channels from one direction (inlet direction), to flow through the channel walls and exit from the channels from the other direction (outlet direction). A dual oxidation catalyst composition can be coated on the wall-flow filter. If such a carrier is utilized, the resulting system will be able to remove particulate matters along with gaseous pollutants. The wall-flow filter carrier can be made from materials commonly known in the art, such as cordierite or silicon carbide.

The carrier may be made of any suitable refractory material, e.g., cordierite, cordierite-alumina, silicon nitride, zircon mullite, spodumene, alumina-silica magnesia, zircon silicate, sillimanite, a magnesium silicate, zircon, petalite, alumina, an aluminosilicate and the like.

The carriers useful for the catalysts of the present invention may also be metallic in nature and be composed of one or more metals or metal alloys. The metallic carriers may be employed in various shapes such as corrugated sheet or monolithic form. Preferred metallic supports include the heat resistant metals and metal alloys such as titanium and stainless steel as well as other alloys in which iron is a substantial or major component. Such alloys may contain one or more of nickel, chromium and/or aluminum, and the total amount of these metals may advantageously comprise at least 15 wt % of the alloy, e.g., 10-25 wt % of chromium, 3-8 wt % of aluminum and up to 20 wt % of nickel. The alloys may also contain small or trace amounts of one or more other metals such as manganese, copper, vanadium, titanium and the like. The surface of the metal carriers may be oxidized at high temperatures, e.g., 1000° C. and higher, to improve the resistance to corrosion of the alloys by forming an oxide layer on the surfaces of the carriers. Such high temperature-induced oxidation may enhance the adherence of the refractory metal oxide support and catalytically promoting metal components to the carrier.

In alternative embodiments, one or more catalyst compositions may be deposited on an open cell foam substrate. Such substrates are well known in the art, and are typically formed of refractory ceramic or metallic materials.

Before describing several exemplary embodiments of the invention, it is to be understood that the invention is not limited to the details of construction or process steps set forth in the following description. The invention is capable of other embodiments and of being practiced in various ways. In the following, preferred designs for the mixed metal oxide composites are provided, including such combinations as recited used alone or in unlimited combinations, the uses for which include catalysts, systems, and methods of other aspects of the present invention.

### Embodiment 1

Provided is a process for the production of particles of catalytic material comprising:

(1) providing a dispersion comprising one or more disperse phases and a continuous phase, the dispersion comprising:
(a) a precursor compound of a first platinum group metal (PGM) and a precursor compound of a first support, and
(b) a precursor compound of a second platinum group metal (PGM) and a precursor compound of a second support,
wherein (a) is in a first phase that is different from a second phase containing (b);
(2) forming an aerosol of the dispersion provided in step (1); and
(3) pyrolyzing the aerosol of step (2) to obtain the particles of catalytic material.

### Embodiment 2

The process of embodiment 1, wherein a first disperse phase comprises (a) and a second disperse phase comprises (b).

### Embodiment 3

The process of embodiment 1, wherein one disperse phase comprises (a) and the continuous phase comprises (b).

### Embodiment 4

The process of any preceding embodiment, wherein the first support comprises an alumina component and the second support comprises a ceria component optionally with a zirconia component.

### Embodiment 5

The process of any preceding embodiment, wherein the first PGM comprises a palladium, rhodium, or platinum component, or mixtures thereof, and the second PGM comprises a palladium, rhodium, or platinum component, or mixtures thereof that is different from the first PGM.

### Embodiment 6

The process of any preceding embodiment, wherein the dispersion further comprises a precursor compound of an alkaline earth metal oxide in a phase different from the phases of (a) and (b).

### Embodiment 7

The process of embodiment 6, wherein the alkaline earth metal oxide comprises a barium, strontium, calcium, or magnesium component.

### Embodiment 8

The process of any preceding embodiment, wherein the wherein the one or more disperse phases comprise a hydrophilic solvent system.

### Embodiment 9

The process of embodiment 8, wherein the hydrophilic solvent system is comprised in droplets, wherein the droplets are preferably stabilized by one or more emulsifying agents.

### Embodiment 10

The process of any preceding embodiment, wherein the continuous phase comprises a hydrophobic solvent system, the hydrophobic solvent system comprising one or more hydrophobic solvents selected from the group consisting of aliphatic and aromatic hydrocarbons, heterocyclic compounds, and mixtures of two or more thereof.

### Embodiment 11

The process of embodiment 10, wherein the hydrophobic solvent comprises aliphatic hydrocarbons comprising one or more of branched and/or unbranched aliphatic (C₄-C₁₂) hydrocarbons, including mixtures of two or more thereof.

### Embodiment 12

The process of any of embodiments 1 to 11 wherein the dispersion provided in step (1) is formed by a process comprising:

(1.a.1) providing a first solution comprising the precursor compound of the first PGM and the precursor compound of the first support a first hydrophilic solvent system;
(1.a.2) providing a second solution comprising the precursor compound of the second PGM and the precursor compound of the second support a second hydrophilic solvent system;
(1.b) providing a hydrophobic solvent system optionally comprising one or more emulsifying agents;
(1.c) dispersing the first and second solutions in the hydrophobic solvent system by mixing for forming the dispersion.

### Embodiment 13

The process of embodiment 12, wherein mixing in step (1.c) is achieved by use of a homogenizer.

### Embodiment 14

The process of any of embodiments 1 to 11 wherein the dispersion provided in step (1) is formed by a process comprising:

(1.a.1) providing a first dispersion comprising a first disperse phase and a first continuous phase, the first dispersion comprising (a); and
(1.a.2) providing a second dispersion comprising a second disperse phase and a second continuous phase, the second dispersion comprising (b).

### Embodiment 15

The process of embodiment 14, wherein the first and second dispersions provided in steps (1.a.1) and (1.a.2) are formed by a process comprising:

providing a first solution comprising the precursor compound of the first PGM and the precursor compound of the first support a first hydrophilic solvent system and dispersing by mixing the first solution into a first hydrophobic solvent system optionally comprising one or more emulsifying agents; and
providing a second solution comprising the precursor compound of the second PGM and the precursor compound of the second support a second hydrophilic solvent system dispersing by mixing the second solution into a second hydrophobic solvent system optionally comprising one or more emulsifying agents.

### Embodiment 16

The process of embodiment 12 or 15, wherein the hydrophobic solvent system(s) independently comprise one or more emulsifying agents that are ionic surfactants, nonionic surfactants, or mixtures thereof.

### Embodiment 17

The process of embodiment 16, wherein the emulsifying agents comprise a nonionic surfactant that is selected from the group consisting of (C₈-C₂₂) alcohols, (C₆-C₂₀) alcohol ethoxylates with 1 to 8 ethylene oxide units, (C₆-C₂₀) alkyl polyglycosides, polyoxyethylene glycol alkyl ethers, polyoxypropylene glycol alkyl ethers, glucoside alkyl ethers, polyoxyethylene glycol alkylphenol ethers, glycerol alkyl esters, sorbitan alkyl esters, polyoxyethylene glycol sorbitan alkyl esters, cocamide monoethanolamine, cocamide diethanolamine, dodecyldimethylamine oxide, block copolymers of polyethylene glycol and polypropylene glycol, polyethoxylated tallow amine, and mixtures of two or more thereof.

### Embodiment 18

The process of embodiment 17, wherein the one or more nonionic surfactants are selected from the group consisting of (C₁₆-C₁₈)alcohols, (C₁₆-C₁₈)alcohol ethoxylates with 2 to 6 ethylene oxide units, (C₈-C₁₄)alkyl polyglycosides, preferably cetyl alcohol, stearyl alcohol, oleyl alcohol, and mixtures of two or more thereof, octaethylene glycol monododecyl ether and/or pentaethylene glycol monododecyl ether, polyoxypropylene glycol alkyl ethers, decyl glucoside, lauryl glucoside, myristil glucoside, octyl glucoside, polyoxyethylene glycol octylphenol ethers, nonoxynol-9, glyceryl laurate, polyglycerol polyricinoleate, sorbitan monolaurate, sorbitan monopalmitate, sorbitan monostearate, sorbitan oleate, polyoxyethylene (20) sorbitan monolaurate, polyoxyethylene (20) sorbitan monopalmitate, polyoxyethylene (20) sorbitan monostearate, polyoxyethylene (20) sorbitan monooleate, cocamide monoethanolamine, cocamide diethanolamine, dodecyldimethylamine oxide, block copolymers of polyethylene glycol and polypropylene glycol, polyethoxylated tallow amine, Stearyl-EO₂, polyglyceryl-2-dipolyhydroxystearate, polyglyceryl-distearate, C13/15-PEG₃, C13-PEG₂, glyceryl monooleate, C16/18-PEG₂, oleyl-PEG₂, PEG₂₀-sorbitan monooleate, functionalized polyisobutene, C16/18-PEG₉, and mixtures of two or more thereof.

### Embodiment 19

The process of embodiment 16, wherein the one or more emulsifying agents is contained in the dispersion in an amount of from 0.01 to 20 wt.-% based on the total weight of the dispersion provided in step (1).

### Embodiment 20

The process of any of the preceding embodiments, wherein the average droplet particle size D50 of the disperse phase is comprised in the range of from 0.05 to 20 μm.

### Embodiment 21

The process of any of the preceding embodiments, wherein the dispersion further comprises one or more rare earth oxides other than ceria in the same phase as (a) and/or (b), the rare earth oxides being selected from the group consisting of lanthana, praseodymia, neodymia, and mixtures of two or three thereof.

### Embodiment 22

The process of any of the preceding embodiments, wherein the concentration of the disperse phase in the dispersion provided in step (1) is comprised in the range of from 1 to 80 wt.-% based on the total weight of the dispersion.

### Embodiment 23

The process of any of the preceding embodiments, wherein the one or more precursor compounds of the first PGM, the first support, the second PGM, and/or the second support comprise one or more salts.

### Embodiment 24

The process of any of the preceding embodiments, wherein the dispersion provided in step (1) comprises the first and second PGMs in an amount ranging from 0.001 to 10 wt.-% calculated as the metal based on the total weight of the dispersion provided in step (1).

### Embodiment 25

The process of any of any of the preceding embodiments, wherein pyrolysis in step (3) is performed in an atmosphere containing oxygen.

### Embodiment 26

The process of any of the preceding embodiments, wherein pyrolysis in step (3) is performed at a temperature comprised in the range of from 600 to 4,000° C.

### Embodiment 27

Particles of catalytic material obtainable and/or obtained by a process according to any of embodiments 1 to 26.

### Embodiment 28

Particles of catalytic material obtainable from flame spray pyrolysis, wherein the particles comprise at least two platinum group metals (PGMs), alumina, ceria and/or zirconia, and optionally one or more oxides of one or more alkaline earth metals or of rare earth elements other than ceria.

### Embodiment 29

The particles of catalytic material of embodiment 28, wherein the average size of the particles of the catalytic material is in the range of from 5 nm to 1 μm.

### Embodiment 30

The particles catalytic material of embodiment 28, comprising by weight of the catalytic material, alumina is in the range of from 1 to 50%, ceria in an amount in the range of 1 to 50%, zirconia in an amount in the range of 10 to 70%; and baria and/or strontia in an amount in the range of 1 to 10%; and optionally, yttria, praseodymia, lanthana, neodymia, or combinations thereof in an amount in the range of 0 to 20%.

### Embodiment 31

The particles catalytic material of embodiment 30, comprising palladium in an amount that is 1.5% by weight of the amount of ceria and/or zirconia and rhodium in an amount that is 0.3% by weight of the amount of alumina.

### Embodiment 32

Use of the particles of catalytic material according to any of embodiments 27 to 31 as a catalyst for treating an exhaust stream of a combustion engine.

### Embodiment 33

A method of treating an exhaust stream of a combustion engine, the method comprising supporting the particles of catalytic material of any of embodiments 27-31 on a carrier to form a catalyst composite and passing the exhaust stream through the catalyst composite.

### Embodiment 34

The method of embodiment 33, wherein the supporting step comprises forming a washcoat comprising the catalytic material slurried in water and coating the washcoat onto the carrier.

### Example

The following prophetic example illustrates the preparation and characterization of representative embodiments related to the present invention. However, the present invention is not limited to the following example.

A first (hydrophilic) solution is formed by dissolving 1.82 g of palladium nitrate.xH₂O (x˜2; mw=266.5 g/mol), 56.6 g of Ce(NO₃)₃.xH₂O (x˜6; mw=385.9 g/mol), 85.9 g of ZrO(NO₃)₂.xH2O (x˜1; mw=249.2 g/mol), and 3.5 g of La(NO₃)₃.xH₂O (x˜6; mw=432.9 g/mol) were dissolved in 560 g of distilled water.

Separately, a second (hydrophilic) solution is formed by dissolving 0.4 g of rhodium nitrate Rh(NO₃)₃.xH₂O (x˜3; mw=280.92 g/mol), 70 g of Al(NO₃)₃.xH₂O (x˜9; mw=375.13 g/mol), were dissolved in 560 g of distilled water.

Separately, a hydrophobic phase is prepared by dissolving 52.6 g of polyglycerol polyricinoleate (Palsgaard® PGPR 4150) in 1.74 kg of xylene.

A first dispersion is formed by mixing the first hydrophilic solution with a portion of the hydrophobic phase, and an emulsion with a 40 wt.-% disperse phase is prepared by homogenization of the mixture using an Ultra-Turrax® T25 (IKA®) for 5 min at 12,500 rpm. The D50 and D90 values for the droplet size of the resulting emulsion are measured.

A second dispersion is formed by mixing the second hydrophilic solution with another portion of the hydrophobic phase, and an emulsion with a 40 wt.-% disperse phase is prepared by homogenization of the mixture using an Ultra-Turrax® T25 (IKA®) for 5 min at 12,500 rpm. The D50 and D90 values for the droplet size of the resulting emulsion are measured.

Flame Spray Pyrolysis

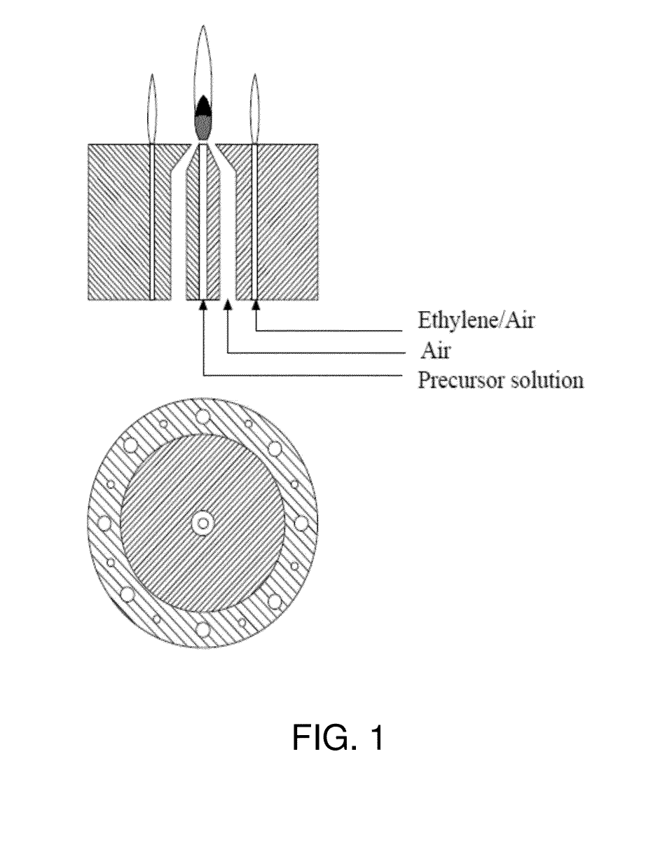

The first and second dispersions obtained according the example are subject to flame spray pyrolysis using a burner configuration as displayed in FIG. 1 under the conditions of precursor flow in the range of 300-400 ml/h, fuel of methane or ethylene, average reactor temperature of 1200° C.

The spray is generated in a two-component nozzle using the precursor emulsion or solution and a gas for dispersion thereof, wherein air or a mixture of nitrogen and oxygen is used as the dispersing gas. The generated spray is ignited by a pilot flame generated from a mixture of methane or ethylene with air and/or a nitrogen/oxygen-mixture. The resulting particles are cooled using a quenching gas and then separated from the gas stream using a woven fabric filter.

The flow of the precursor solution and the flow of air (or a mixture of nitrogen and oxygen) and ethylene or methane to the main (two-component) and auxiliary nozzles (pilot flame) are regulated such that an average temperature is sustained in the burning chamber for the pyrolysis of the precursor emulsions and solutions, respectively. After the particles of catalytic material from flame spray pyrolysis are obtained, the powders are analyzed in their fresh state as well as after having been subject to hydrothermal aging by exposure to air with 10 vol. % of H₂O at a temperature of 1100° C. for 40 hours. The characteristics of the fresh and aged products are analyzed.

While this invention has been described with an emphasis upon preferred embodiments, it will be obvious to those of ordinary skill in the art that variations in the preferred devices and methods may be used and that it is intended that the invention may be practiced otherwise than as specifically described herein. Accordingly, this invention includes all modifications encompassed within the spirit and scope of the invention as defined by the claims that follow.

What is claimed:

1. A process for the production of particles of catalytic material comprising:
(1) providing a dispersion comprising one or more disperse phases and a continuous phase, the dispersion comprising:
(a) a precursor compound of a first platinum group metal (PGM) and a precursor compound of a first support, and
(b) a precursor compound of a second platinum group metal (PGM) and a precursor compound of a second support,
wherein (a) is in a first phase that is different from a second phase containing (b);
(2) forming an aerosol of the dispersion provided in step (1); and
(3) pyrolyzing the aerosol of step (2) to obtain the particles of catalytic material.

2. The process of claim 1, wherein a first disperse phase comprises (a) and a second disperse phase comprises (b).

3. The process of claim 1, wherein one disperse phase comprises (a) and the continuous phase comprises (b).

4. The process of claim 1, wherein the first support comprises an alumina component and the second support comprises a ceria component optionally with a zirconia component.

5. The process of claim 1, wherein the first PGM comprises a palladium, rhodium, or platinum component, or mixtures thereof, and the second PGM comprises a palladium, rhodium, or platinum component, or mixtures thereof that is different from the first PGM.

6. The process of claim 1, wherein the dispersion further comprises a precursor compound of an alkaline earth metal oxide in a phase different from the phases of (a) and (b).

7. The process of claim 6, wherein the alkaline earth metal oxide comprises one or more of a barium, strontium, calcium, or magnesium component.

8. The process of claim 1, wherein the wherein the one or more disperse phases comprise a hydrophilic solvent system.

9. The process of claim 1, wherein the continuous phase comprises a hydrophobic solvent system, the hydrophobic solvent system comprising one or more hydrophobic solvents selected from the group consisting of aliphatic and aromatic hydrocarbons, heterocyclic compounds, and mixtures of two or more thereof.

10. The process of claim 1, wherein the dispersion provided in step (1) is formed by a process comprising:
(1.a.1) providing a first solution comprising the precursor compound of the first PGM and the precursor compound of the first support a first hydrophilic solvent system;
(1.a.2) providing a second solution comprising the precursor compound of the second PGM and the precursor compound of the second support a second hydrophilic solvent system;
(1.b) providing a hydrophobic solvent system optionally comprising one or more emulsifying agents; and
(1.c) dispersing the first and second solutions in the hydrophobic solvent system by mixing for forming the dispersion.

11. The process of claim 10, wherein mixing in step (1.c) is achieved by use of a homogenizer.

12. The process of claim 1, wherein the dispersion provided in step (1) is formed by a process comprising:
(1.a.1) providing a first dispersion comprising a first disperse phase and a first continuous phase, the first dispersion comprising (a); and
(1.a.2) providing a second dispersion comprising a second disperse phase and a second continuous phase, the second dispersion comprising (b).

13. The process of claim 12, wherein the first and second dispersions provided in steps (1.a.1) and (1.a.2) are formed by a process comprising:
providing a first solution comprising the precursor compound of the first PGM and the precursor compound of the first support a first hydrophilic solvent system and dispersing by mixing the first solution into a first hydrophobic solvent system optionally comprising one or more emulsifying agents; and
providing a second solution comprising the precursor compound of the second PGM and the precursor compound of the second support a second hydrophilic solvent system dispersing by mixing the second solution into a second hydrophobic solvent system optionally comprising one or more emulsifying agents.

14. The process of claim 1, wherein the average droplet particle size D50 of the disperse phase is comprised in the range of from 0.05 to 20 μm.

15. The process of claim 1, wherein the dispersion further comprises one or more rare earth oxides other than ceria in the same phase as (a) and/or (b), the rare earth oxides being selected from the group consisting of lanthana, praseodymia, neodymia, and mixtures of two or three thereof.

16. The process of claim 1, wherein the concentration of the disperse phase in the dispersion provided in step (1) is comprised in the range of from 1 to 80 wt.-% based on the total weight of the dispersion.

17. The process of claim 1, wherein the one or more precursor compounds of the first PGM, the first support, the second PGM, and/or the second support comprise one or more salts.

18. The process of claim 1, wherein pyrolysis in step (3) is performed in an atmosphere containing oxygen.

19. The process of claim 1, wherein pyrolysis in step (3) is performed at a temperature comprised in the range of from 600 to 4,000° C.

20. Particles of catalytic material obtainable from flame spray pyrolysis, wherein the particles comprise at least two platinum group metals (PGMs), alumina, ceria and/or zirconia, and optionally one or more oxides of one or more alkaline earth metals or of rare earth elements other than ceria.

21. The particles of catalytic material of claim 20, wherein the average size of the particles of the catalytic material is in the range of from 5 nm to 1 μm.

22. The particles catalytic material of claim 20 comprising by weight of the catalytic material, alumina in the range of from 1 to 50%, ceria in an amount in the range of 1 to 50%, zirconia in an amount in the range of 10 to 70%; baria and/or strontia in an amount in the range of 1 to 10%; and optionally, yttria, praseodymia, lanthana, neodymia, or combinations thereof in an amount in the range of 0 to 20%; palladium in an amount that is 1.5% by weight of the amount of ceria and/or zirconia and rhodium in an amount that is 0.3% by weight of the amount of alumina.

23. A method of treating an exhaust stream of a combustion engine, the method comprising supporting the particles of catalytic material of claim 20 on a carrier to form a catalyst composite and passing the exhaust stream through the catalyst composite.

24. The method of claim 23, wherein the supporting step comprises forming a washcoat comprising the catalytic material slurried in water and coating the washcoat onto the carrier.
